(19) United States
(12) Patent Application Publication
(10) Pub. No.: US 2022/0372280 A1
(43) Pub. Date: Nov. 24, 2022

(54) FLAME RETARDANT POLYCARBONATE COMPOSITIONS AND THIN-WALL ARTICLES MADE THEREFROM

(71) Applicant: SHPP Global Technologies B.V., Bergen op Zoom (NL)

(72) Inventors: Fabrizio Micciche, Breda (NL); Rein Mollerus Faber, Bergen op Zoom (NL); Mark Adrianus Johannes Van Der Mee, Breda (NL); Robert Dirk Van De Grampel, Tholen (NL); Tony Farrell, Bergen op Zoom (NL)

(21) Appl. No.: 17/765,093

(22) PCT Filed: Sep. 30, 2020
(86) PCT No.: PCT/IB2020/059120

§ 371 Date: Mar. 30, 2022

Related U.S. Application Data
(60) Provisional application No. 62/908,096, filed on Sep. 30, 2019.

(51) Int. Cl. C08L 69/00; C08L 83/04

(52) U.S. Cl. CPC C08L 69/00; C08L 83/04; C08L 2201/08; C08L 2203/20; C08L 2205/02; C08L 2201/02

(57) ABSTRACT

A flame retardant composition comprising: 34-94 wt % of a homopolycarbonate, acopolycarbonate, or a combination thereof; 5-85 wt % poly(carbonate-siloxane), in an amount effective to provide 2-6 wt % dimethyl siloxane; 0.05-0.6 w t%, preferably 0.2-0.4 wt%, of a C₁₋₁₆ alkyl sulfonate salt flame retardant; 1-15 wt % of a mineral-filled silicone flame retardant synergist; 0.05-0.5 wt % of an anti-drip agent; wherein each amount is based on the total weight of the flame retardant composition, which sums to 100 wt %; and wherein a molded sample of the flame retardant composition has a Vicat softening temperature of greater than or equal to 140° C. as measured according to the ISO-306 standard at a load of 10 N and a heating rate of 50° C. per hour, and a flame test rating of V0 as measured according to UL-94 at a thickness of 1.0 millimeter, or at a thickness of 0.8 millimeter.

### CROSS REFERENCE TO RELATED APPLICATIONS

This application claims the benefit of U.S. Application No. 62/908096, filed on Sep. 30, 2019, which is incorporated herein by reference in its entirety.

### BACKGROUND

This disclosure relates to flame retardant compositions, and in particular to flame retardant compositions, methods of manufacture, and uses thereof in thin-wall articles.

Polycarbonates are useful in the manufacture of articles and components for a wide range of applications, from automotive parts to electronic appliances. Because of their broad use, particularly in electronics, it is desirable to provide flame retardant polycarbonates with thermal and impact resistance. Such properties may be particularly difficult to achieve in thin-wall applications, for example in applications where the thickness of the polycarbonate at any location in the article is from 0.2 to 1.0 millimeters, or from 0.2 to 0.8 millimeters, or from 0.2 to 0.4 millimeters.

There accordingly remains a need in the art for flame retardant compositions having good heat resistance and low-temperature impact resistance in thin-wall articles.

### SUMMARY

The above-described and other deficiencies of the art are met by a flame retardant composition comprising: 34-94 wt % of a homopolycarbonate, a copolycarbonate, or a combination thereof; 5-85 wt % poly(carbonate-siloxane), in an amount effective to provide 2-6 wt % dimethyl siloxane; 0.05-0.6 wt %, preferably 0.1-0.4 wt %, of a C₁₋₁₆ alkyl sulfonate salt flame retardant; 1-15 wt % of a mineral-filled silicone flame retardant synergist; 0.05-0.5 wt % of an anti-drip agent; optionally, 0.001-10 wt % of an additive composition, or 1-20 wt % of a glass fiber composition, or a combination thereof wherein each amount is based on the total weight of the flame retardant composition, which sums to 100 wt %; and wherein a molded sample of the flame retardant composition has a Vicat softening temperature of greater than or equal to 140° C. as measured according to the ISO-306 standard at a load of 10 N and a heating rate of 50° C. per hour, and a flame test rating of V0 as measured according to UL-94 at a thickness of 1.0 millimeter, or at a thickness of 0.8 millimeter.

In another aspect, a method of manufacture comprises combining the above-described components to form a flame retardant composition.

In yet another aspect, an article comprises the above-described flame retardant composition.

In still another aspect, a method of manufacture of an article comprises molding, extruding, or shaping the above-described flame retardant composition into an article.

The above described and other features are exemplified by the following detailed description, examples, and claims,

### DETAILED DESCRIPTION

Poly(carbonate-siloxane)s may provide advantages over standard polycarbonate, such as low temperature impact, high ductility, better flow, chemical resistance, and hydrolytic stability. However, with the increasing demand on weight reduction and complexity in product designs, there is a need to develop engineering thermoplastic compositions able to fulfill market trends and more stringent regulations including flame performance at low thicknesses.

One skilled in the art may achieve thin wall UL94 V0 performance by adding phosphorous-based additives, however, undesirably, this may result in a reduction in one or both of the Vicat softening temperature and the heat deformation temperature (HDT). Therefore, there is a need for flame retardant compositions with thin-wall UL94 flame retardance (e.g., V0 at 0.8 millimeter), while maintaining the advantageous properties of poly(carbonate-siloxane)s (e.g., impact resistance).

Surprisingly and unexpectedly, the inventors hereof discovered that molded samples of compositions that include a homopolycarbonate, a copolycarbonate, or a combination thereof, a poly(carbonate-siloxane), a mineral-filled silicone flame retardant synergist, an anti-drip agent, and a C₁₋₁₆ alkyl sulfonate salt flame retardant provide the combination of a flame test rating of V0 at a thickness of 1.0 mm and at a thickness of 0.8 mm and low-temperature impact resistance. Advantageously, the flame retardant compositions maintain thermal properties such as the Vicat softening temperature.

“Polycarbonate” as used herein means a polymer having repeating structural carbonate units of formula (1)

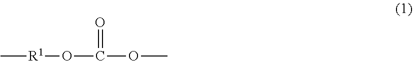

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ may be derived from an aromatic dihydroxy compound of the formula HO—R¹—OH, in particular of formula (2)

HO—A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ may be derived from a bisphenol of formula (3)

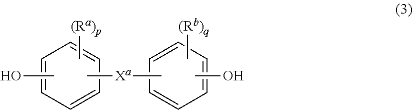

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂-, —C(O)—, or a C₁₋₆₀ organic group. The organic bridging group may be cyclic or acyclic, aromatic or non-aromatic, and may further comprise heteroatoms such as halogens, oxygen, nitrogen, sulfur, silicon, or phosphorous. The ₁₋₆₀ organic group may be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})—wherein R^{e} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein J¹ and J² are the same or different C₁₋₆ alkylene and G is a C₃₋₁₂ cycloalkylidene or a C₆₋₁₆ arylene.

For example, X^{a} may be a substituted C₃₋₁₈ cycloalkylidene of formula (4)

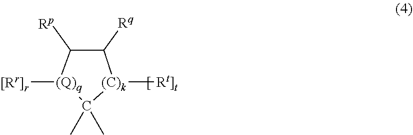

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{r} and R^{p} taken together form a second aromatic group. When R^{q} and R^{t} taken together form an aromatic group, R^{p} may be a double-bonded oxygen atom, i.e., a ketone, or Q may be —N(Z)— wherein Z is phenyl.

Bisphenols wherein X^{a} is a cycloalkylidene of formula (4) may be used in the manufacture of polycarbonates containing phthalimidine carbonate units of formula (1a)

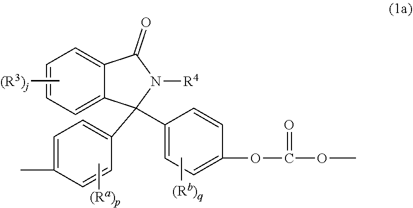

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

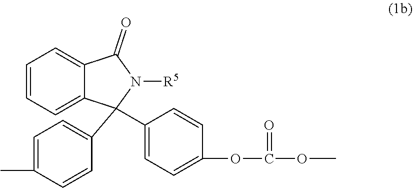

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl may be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (1c) and (1d)

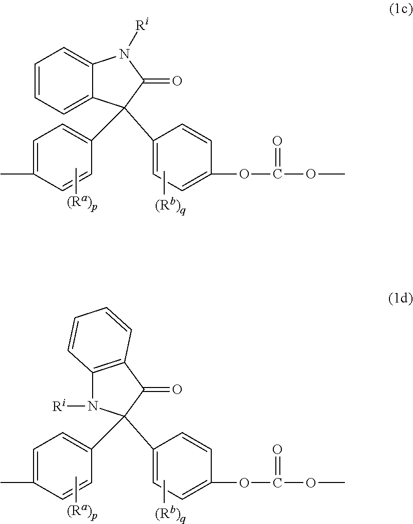

wherein R^{a} and R^{b} are each independently a halogen, C₁₋₁₂ alkoxy, or C₁₋₁₂ alkyl, p and q are each independently 0 to 4, and Rⁱ is C₁₋₁₂ alkyl, phenyl optionally substituted with 1 to 5 C₁₋₁₀ alkyl, or benzyl optionally substituted with 1 to 5 C₁₋₁₀ alkyls. In an aspect, R^{a}and R^{b} are each methyl, p and q are each independently 0 or 1, and Rⁱ is C₁₋₄ alkyl or phenyl.

Other examples of bisphenol carbonate units derived from of bisphenols (3) wherein X^{a} is a substituted or unsubstituted C₃₋₁₈ cycloalkylidene include the cyclohexylidene-bridged bisphenol of formula (1e)

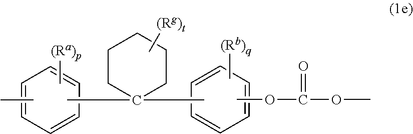

wherein R^{a} and le are each independently C₁₋₁₂ alkyl, R^{g} is C₁₋₁₂ alkyl, p and q are each independently 0 to 4, and t is 0 to 10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0 to 5. In another specific aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that X^{a} is 3,3-dimethyl-5-methyl cyclohexylidene.

Examples of other bisphenol carbonate units derived from bisphenol (3) wherein X^{a} is a substituted or unsubstituted C₃₋₁₈ cycloalkylidene include adamantyl units of formula (1f) and fluorenyl units of formula (1g)

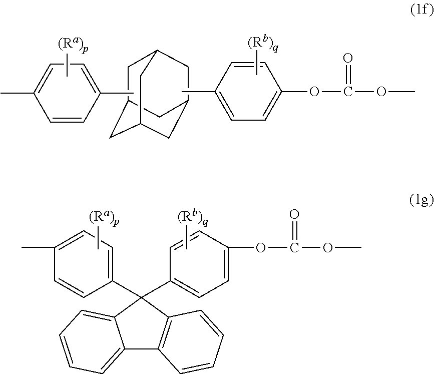

wherein R^{a} and R^{b} are each independently C₁₋₁₂ alkyl, and p and q are each independently 1 to 4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

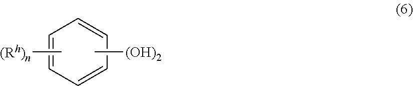

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of dihydroxy compounds that may be used are described, for example, in WO 2013/175448 A1, US 2014/0295363, and WO 2014/072923. Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination may also be used. In a specific aspect, the polycarbonate is a linear homopolymer derived from bisphenol A, in which each of A¹ and A² is p-phenylene and Y¹ is isopropylidene in formula (3).

The polycarbonates may have an intrinsic viscosity, as determined in chloroform at 25° C., of 0.3 to 1.5 deciliters per gram (dl/gm), preferably 0.45 to 1.0 dl/gm. The polycarbonates may have a weight average molecular weight (Mw) of 20,000 to 30,000 grams per mole (g/mol), preferably 20,000 to 25,000 g/mol, 25,000 g/mol to 35,000 g/mol, preferably 27,000 to 32,000 g/mol as measured by gel permeation chromatography (GPC), using a crosslinked styrene-divinylbenzene column and calibrated to bisphenol A homopolycarbonate references. GPC samples are prepared at a concentration of 1 mg per ml, and are eluted at a flow rate of 1.5 ml per minute.

The homopolycarbonate, the copolycarbonate, or a combination thereof may be present, for example, from 34-94 wt %, 40-80 wt %, 50-80 wt %, 60-80 wt %, 70-80 wt %, or 65-75 wt %, each based on the total weight of the flame retardant composition.

“Polycarbonates” includes homopolycarbonates (wherein each R¹ in the polymer is the same), copolymers comprising different R¹ moieties in the carbonate (“copolycarbonates”). The copolycarbonates may comprised bisphenol A units at least one other type of unit,

The flame retardant composition includes a poly(carbonate-siloxane), also referred to in the art as a polycarbonate-polysiloxane copolymer. The polysiloxane blocks comprise repeating diorganosiloxane units as in formula (10)

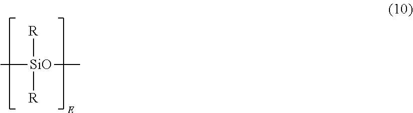

wherein each R is independently a C₁₋₁₃ monovalent organic group. For example, R may be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups may be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups may be used in the same copolymer.

The value of E in formula (10) may vary widely depending on the type and relative amount of each component in the flame retardant composition, the desired properties of the composition, and like considerations. Generally, E has an average value of 2 to 1,000, preferably 2 to 500, 2 to 200, or 2 to 125, 5 to 80, or 10 to 70. In an aspect, E has an average value of 10 to 80 or 10 to 40, and in still another aspect, E has an average value of 40 to 80, or 40 to 70. Where E is of a lower value, e.g., less than 40, it may be desirable to use a relatively larger amount of the poly(carbonate-siloxane) copolymer. Conversely, where E is of a higher value, e.g., greater than 40, a relatively lower amount of the poly(carbonate-siloxane) copolymer may be used. A combination of a first and a second (or more) poly(carbonate-siloxane) copolymers may be used, wherein the average value of E of the first copolymer is less than the average value of E of the second copolymer.

In an aspect, the polysiloxane blocks are of formula (11)

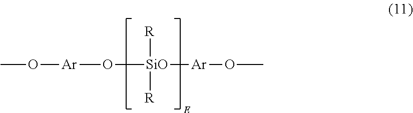

wherein E and R are as defined if formula (10); each R may be the same or different and is as defined above; and Ar may be the same or different and is a substituted or unsubstituted C₆₋₃₀ arylene, wherein the bonds are directly connected to an aromatic moiety. Ar groups in formula (11) may be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (13)

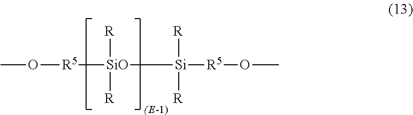

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (14)

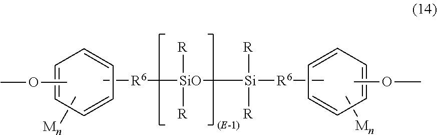

wherein R and E are as defined above. R⁶ in formula (14) is a divalent C₂₋₈ aliphatic group. Each M in formula (14) may be the same or different, and may be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

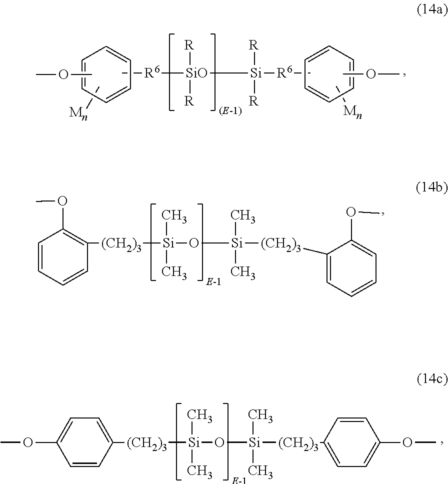

or a combination thereof, wherein E has an average value of 2 to 200, 2 to 125, 5 to 125, 5 to 100, 5 to 50, 20 to 80, or 5 to 20.

Blocks of formula (14) may be derived from the corresponding dihydroxy polysiloxane, which in turn may be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers may then be manufactured, for example, by the synthetic procedure of European Patent Application Publication No. 0 524 731 A1 of Hoover, page 5, Preparation 2.

Transparent poly(carbonate-siloxane) copolymers comprise carbonate units (1) derived from bisphenol A, and repeating siloxane units (14a), (14b), (14c), or a combination thereof (preferably of formula 14a), wherein E has an average value of 4 to 50, 4 to 15, preferably 5 to 15, more preferably 6 to 15, and still more preferably 7 to 10. The transparent copolymers may be manufactured using one or both of the tube reactor processes described in U.S. Patent Application No. 2004/0039145A1 or the process described in U.S. Pat. No. 6,723,864 may be used to synthesize the poly(carbonate-siloxane) copolymers.

The poly(carbonate-siloxane) copolymers may comprise 50 to 99 weight percent of carbonate units and 1 to 50 weight percent siloxane units. Within this range, the poly(carbonate-siloxane) copolymer may comprise 70 to 98 weight percent, more preferably 75 to 97 weight percent of carbonate units and 2 to 30 weight percent, more preferably 3 to 25 weight percent siloxane units.

In an aspect, a blend is used, in particular a blend of a bisphenol A homopolycarbonate and a poly(carbonate-siloxane) block copolymer of bisphenol A blocks and eugenol capped polydimethylsiloxane blocks, of the formula

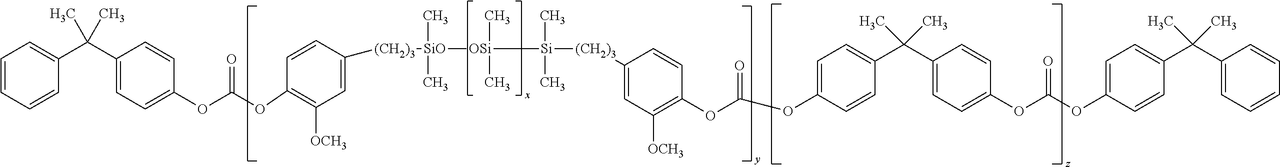

wherein x is 1 to 200, preferably 5 to 85, preferably 10 to 70, preferably 15 to 65, and more preferably 40 to 60; x is 1 to 500, or 10 to 200, and z is 1 to 1000, or 10 to 800. In an aspect, x is 1 to 200, y is 1 to 90 and z is 1 to 600, and in another aspect, x is 30 to 50, y is 10 to 30 and z is 45 to 600. The polysiloxane blocks may be randomly distributed or controlled distributed among the polycarbonate blocks.

In an aspect, the poly(carbonate-siloxane) copolymer comprises 10 weight percent (wt %) or less, preferably 6 wt % or less, and more preferably 4 wt % or less, of the polysiloxane based on the total weight of the poly(carbonate-siloxane) copolymer and are generally optically transparent and are commercially available under the name EXL-T from SABIC. In another aspect, the poly(carbonate-siloxane) copolymer comprises 10 wt % or more, preferably 12 wt % or more, and more preferably 14 wt % or more, of the polysiloxane copolymer based on the total weight of the poly(carbonate-siloxane) copolymer, are generally optically opaque and are commercially available under the trade name EXL-P from SABIC.

The flame retardant composition may include a poly(carbonate-siloxane) having 40 wt % siloxane content, a poly(carbonate-siloxane) having 20 wt % siloxane content, a poly(carbonate-siloxane) having 6 wt % siloxane content, or a combination thereof. In some aspects, the flame retardant composition includes 5-15 wt %, or 5-10 wt % of a poly(carbonate-siloxane) copolymer having 40 wt % siloxane content. In some aspects, the flame retardant composition includes 10-25 wt %, 10-20 wt %, or 10-15 wt % of a poly(carbonate-siloxane) copolymer having 20 wt % siloxane content. In some aspects, the flame retardant composition includes 35-82 wt %, 45-82 wt %, 55-82 wt %, or 65-82 wt % of a poly(carbonate-siloxane) copolymer having 6 wt % siloxane content.

Poly(carbonate-siloxane)s may have a weight average molecular weight of 2,000 to 100,000 g/mol, preferably 5,000 to 50,000 g/mol as measured by gel permeation chromatography using a crosslinked styrene-divinyl benzene column, at a sample concentration of 1 milligram per milliliter, and as calibrated with polycarbonate standards.

The poly(carbonate-siloxane)s may have a melt volume flow rate, measured at 300° C./1.2 kg, of 1 to 50 cubic centimeters per 10 minutes (cc/10 min), preferably 2 to 30 cc/10 min. Combinations of the poly(carbonate-siloxane)s of different flow properties may be used to achieve the overall desired flow property.

The poly(carbonate-siloxane)s may be present, for example, from 5-85 wt %, 5-70 wt %, 5-50 wt %, 5-35 wt %, 10-70 wt %, 10-50 wt %, 10-35 wt %, 10-30 wt %, 15-50 wt %, or 15-30 wt %, each based on the total weight of the flame retardant composition.

The flame retardant compositions include C₁₋₁₆ alkyl sulfonate salt flame retardants. Examples include potassium perfluorobutane sulfonate (Rimar salt), potassium perfluoroctane sulfonate, and tetraethylammonium perfluorohexane sulfonate. The C₁₋₁₆ alkyl sulfonate salt flame retardants are present in an amount of 0.05-0.6 wt %, preferably 0.1-0.4 wt % based on the total weight of the flame retardant composition. Additional flame retardants different from the C₁₋₁₆ alkyl sulfonate salt flame retardants may be present and may include salts of aromatic sulfonates such as sodium benzene sulfonate, sodium toluene sulfonate (NaTS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AlF₆, BaSiF₆, KBF₄, K₃AlF₆, KAlF₄, K₂SiF₆, or Na₃AlF₆ or the like. Rimar salt and KSS and NaTS, alone or in combination with other flame retardants, are particularly useful. When present, inorganic flame retardant salts are generally present in amounts of 0.01-5.0 parts by weight, more preferably 0.1 to 1.0 parts by weight, based on 100 parts by weight of the flame retardant composition. The aromatic sulfonate salt may be present in an amount of 0.01 to 0.1 wt %, preferably, 0.02 to 0.06 wt %, and more preferably, 0.03 to 0.05 wt %, based on 100 parts by weight of the flame retardant composition.

In an aspect, the flame retardant different from the C₁₋₁₆ alkyl sulfonate salt flame retardant is an organophosphorous flame retardant. In the organophosphorous flame retardants that have at least one organic aromatic group, the aromatic group may be a substituted or unsubstituted C₃₋₃₀ group containing one or more of a monocyclic or polycyclic aromatic moiety (which may optionally contain with up to three heteroatoms (N, O, P, S, or Si)) and optionally further containing one or more nonaromatic moieties, for example alkyl, alkenyl, alkynyl, or cycloalkyl. The aromatic moiety of the aromatic group may be directly bonded to the organophosphorous flame retardant, or bonded via another moiety, for example an alkylene group. The aromatic moiety of the aromatic group may be directly bonded to the organophosphorous flame retardant, or bonded via another moiety, for example an alkylene group. In an aspect the aromatic group is the same as an aromatic group of the polycarbonate backbone, such as a bisphenol group (e.g., bisphenol A), a monoarylene group (e.g., a 1,3-phenylene or a 1,4-phenylene), or a combination comprising at least one of the foregoing.

The organophosphorous flame retardant may include a phosphate (P(═O)(OR)₃), phosphite (P(OR)₃), phosphonate (RP(═O)(OR)₂), phosphinate (R₂P(═O)(OR)), phosphine oxide (R₃P(═O)), or phosphine (R₃P), wherein each R in the foregoing organophosphorous flame retardants may be the same or different, provided that at least one R is an aromatic group. A combination of different organophosphorous flame retardants may be used. The aromatic group may be directly or indirectly bonded to the phosphorus, or to an oxygen of the organophosphorous flame retardant (i.e., an ester).

In an aspect the organophosphorous flame retardant is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups may be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional organophosphorous flame retardants are also useful, for example, compounds of the formulas

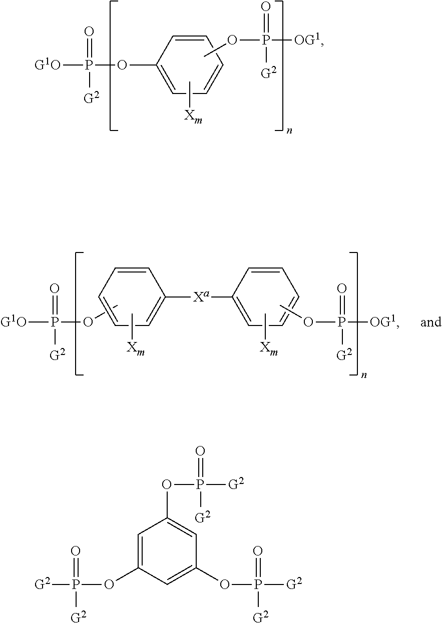

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0 to 4, and n is 1 to 30. In a specific aspect, X^{a} is a single bond, methylene, isopropylidene, or 3,3,5-trimethylcyclohexylidene.

Specific organophosphorous flame retardants are inclusive of acid esters of formula (13)

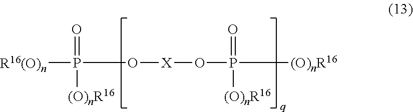

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, specifically by C₁₋₄ alkyl and X is a mono- or poly-nuclear aromatic C₆₋₃₀ moiety or a linear or branched C₂₋₃₀ aliphatic radical, which may be OH-substituted and may contain up to 8 ether bonds, provided that at least one R¹⁶ or X is an aromatic group; each n is independently 0 or 1; and q is from 0.5 to 30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5 to 30. In some aspects each R¹⁶ is aromatic, e.g., phenyl; each X is a mono- or poly-nuclear aromatic C₆₋₃₀ moiety, including a moiety derived from formula (2); n is one; and q is from 0.8 to 15. In other aspects, each R¹⁶ is phenyl; X is cresyl, xylenyl, propylphenyl, or butylphenyl, one of the following divalent groups

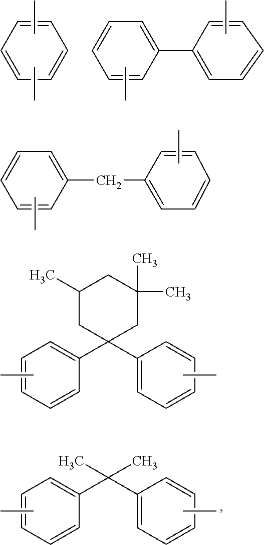

or a combination comprising one or more of the foregoing; n is 1; and q is from 1 to 5, or from 1 to 2. In some aspects at least one R¹⁶ or X corresponds to a monomer used to form the polycarbonate, e.g., bisphenol A, resorcinol, or the like. Organophosphorous flame retardants of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The organophosphorous flame retardants containing a phosphorus-nitrogen bond may be a phosphazene, phosphonitrilic chloride, phosphorus ester amide, phosphoric acid amide, phosphonic acid amide, phosphinic acid amide, or tris(aziridinyl) phosphine oxide. These flame-retardant additives are commercially available. In an aspect, the organophosphorous flame retardant containing a phosphorus-nitrogen bond is a phosphazene or cyclic phosphazene of the formulas

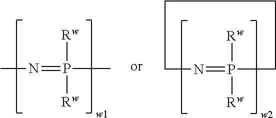

wherein w1 is 3 to 10,000; w2 is 3 to 25, or 3 to 7; and each R^{w} is independently a C₁₋₁₂ alkyl, alkenyl, alkoxy, aryl, aryloxy, or polyoxyalkylene group. In the foregoing groups at least one hydrogen atom of these groups may be substituted with a group having an N, S, O, or F atom, or an amino group. For example, each R^{w} may be a substituted or unsubstituted phenoxy, an amino, or a polyoxyalkylene group. Any given R^{w} may further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. In an aspect, the phosphazene has a structure represented by the formula

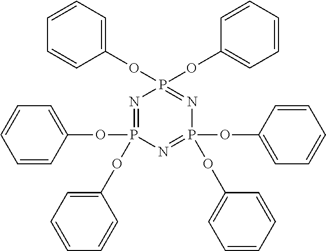 [SMILES: c1ccc(OP2(Oc3ccccc3)=NP(Oc3ccccc3)(Oc3ccccc3)=NP(Oc3ccccc3)(Oc3ccccc3)=N2)cc1]

Commercially available phenoxyphosphazenes having the aforementioned structures are LY202 manufactured and distributed by Lanyin Chemical Co., Ltd, FP-110 manufactured and distributed by Fushimi Pharmaceutical Co., Ltd, and SPB-100 manufactured and distributed by Otsuka Chemical Co., Ltd.

An anti-drip agent is present in the flame retardant composition, for example a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. TSAN may comprise 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate or SAN to form an agglomerated material for use as an anti-drip agent. Either method may be used to produce an encapsulated fluoropolymer. Anti-drip agents are generally used in amounts of 0.05 to 0.5 percent by weight, based on 100 percent by weight of the flame retardant composition.

The flame retardant compositions include a mineral-filled silicone flame retardant synergist. Minerals that may be used include carbonates, oxides, nitrides, or sulfates of various elements, such as aluminum, barium, boron, calcium, magnesium, silicon, and titanium. A combination of these elements may be used. Exemplary mineral fillers include calcium carbonate, barium sulfate, magnesium silicate, calcium silicate, aluminum silicate, aluminum calcium silicate, aluminum silicon silicate, alumina, silica, titania (such as rutile and anatase), barium titanate, strontium titanate, or a combination thereof. A combination of different mineral fillers may be used. The mineral filler may be naturally derived, e.g., dolomite, bentonite, talc, corundum, phyllosilicate (mica), wollastonite, or kaolin clay; or the mineral filler may process. For example, the silica may be in fumed, precipitated, or mined forms. These silicas are typically characterized by surface areas greater than about 50 m²/gm. Fumed silica may be used, which may have a surface area as high as 900 m² /gm, but preferably has a surface area of 50 to 400 m /gm The mineral filler may optionally be surface treated with a silicon-containing compound, for example, an organofunctional alkoxy silane coupling agent. A zirconate or titanate coupling agent may be used. Such coupling agents may improve the dispersion of the filler in the polysiloxane.

The silicone may be a polysiloxane (a diorganopolysiloxane) wherein the organic groups may be C₁₋₆ alkyl, C₆₋₁₂ aryl, or a combination thereof. The organic groups may optionally be substituted with halogen, for example 1 to 3 chlorine, bromine, or fluorine atoms. In an aspect the organic groups may be methyl (a polydimethylsiloxane). Functional groups, such as hydroxy, C₁₋₆ alkoxy, hydride, or vinyl groups may be present in the mineral-filled silicone flame retardant synergist, or in the silicone used to prepare the mineral-filled silicone flame retardant synergist. The silicone may include other types of silicone units, arising, for example, from the crosslinking of the silicone during production of the mineral-filled silicone flame retardant synergist.

In an aspect, the mineral-filled silicone flame retardant synergist is a silicone flame retardant additive present in an amount of 1-99 wt %, or 1-75 wt %, or 1-50 wt %, or 1-25 wt %, or 1 to 20 wt % in combination with a mineral filler synergist present in an amount of 1-99 wt %, or 25-99 wt %, or 50-99 wt %, or 75-99 wt %, or 80-90 wt %, each based on the total weight of the combination.

In another aspect, the weight ratio of mineral to silicone in the mineral-filled silicone flame retardant synergist may be 5:95 to 95:5, or 20:80 to 80:20, or 60:40 to 40:60. The mineral-filled silicone flame retardant synergist may comprise 1-20 wt % silicon, or 2-18 wt % silicon, or 3-15 wt % silicon, or 5-12 wt % silicon, or 6-10 wt % silicon, or 7-8 wt % silicon. Examples of mineral-filled silicone flame retardant synergist and their methods of manufacture from a silicone gum are disclosed in WO 2011/16136 A2. Exemplary mineral-filled silicone flame retardant synergists are commercially available under the trade name DynaSil™ from Polymer Dynamix, New Jersey, USA. The mineral-filled silicone flame retardant synergist may serve as a cost-effective replacement for antimony-containing synergists. Not wishing to be bound by theory, the mineral-filled silicone flame retardant synergist flows to the flame front and forms a thin glassy barrier to form a robust char when burning. In some aspects, the mineral-filled silicone flame retardant synergist is a silicone composition, for example a polydimethylsiloxane, comprising fumed silica.

The mineral-filled silicone flame retardant synergist may be present, for example, form 1-15 wt %, 1-12 wt %, 1-10 wt %, 1-8 wt %, 1-5 wt %, 2-15 wt %, 2-12 wt %, 2-10 wt %, 1-8 wt %, 2-5 wt %, 3-15 wt %, 3-12 wt %, 3-8 wt %, 4-15 wt %, 4-12 wt %, 4-10 wt %, 4-8 wt %, 5-15 wt %, 5-12 wt %, or 5-10 wt %, 1 to less than 7.5 wt %, or 2.5 to less than 7.5 wt %, each based on the total weight of the flame retardant composition.

The flame retardant compositions may further comprise an additive composition that includes various additives ordinarily incorporated into polymer compositions of this type, with the proviso that the additive(s) are selected so as to not significantly adversely affect the desired properties of the flame retardant composition, in particular heat resistance, transparency, and flame retardance. Combinations of additives may be used. The additive composition may include an impact modifier, flow modifier, particulate filler (e.g., a particulate polytetrafluoroethylene (PTFE), glass, carbon, mineral, or metal), reinforcing filler (e.g., glass fibers such as E, A, C, ECR, R, S, D, or NE glasses, or the like), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, a flame retardant different from the C₁₋₁₆ alkyl sulfonate salt flame retardant or a mineral-filled silicone flame retardant synergist, or a combination thereof. For example, the total amount of the additive composition may be 0.001 to 10.0 wt %, or 0.01 to 5 wt %, or 0.1 to 5 wt %, each based on the total weight of the flame retardant composition.

There is considerable overlap among plasticizers, lubricants, and mold release agents, which include, for example, phthalic acid esters (e.g., octyl-4,5-epoxy-hexahydrophthalate), tris-(octoxycarbonylethyl)isocyanurate, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); fatty acid esters (e.g., C₁₋₃₂ alkyl stearyl esters, such as methyl stearate and stearyl stearate and esters of stearic acid such as pentaerythritol tetrastearate, glycerol tristearate (GTS), and the like), waxes (e.g., beeswax, montan wax, paraffin wax, or the like), or combinations comprising at least one of the foregoing plasticizers, lubricants, and mold release agents. These are generally used in amounts of 0.01-5 wt %, based on the total weight of total weight of the flame retardant composition, which sums to 100 wt %.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01-0.2, or 0.01-0.1 parts by weight, based on the total weight of the flame retardant composition, which sums to 100 wt %.

The flame retardant composition is essentially free of chlorine and bromine. “Essentially free of chlorine and bromine” refers to materials produced without the intentional addition of chlorine or bromine or chlorine or bromine containing materials. It is understood however that in facilities that process multiple products a certain amount of cross contamination may occur resulting in bromine or chlorine levels typically on the parts per million by weight scale. With this understanding it may be readily appreciated that “essentially free of bromine and chlorine” may be defined as having a bromine or chlorine content of less than or equal to 100 parts per million by weight (ppm), less than or equal to 75 ppm, or less than or equal to 50 ppm. In some aspects, “essentially free of bromine and chlorine” means a total bromine and chlorine content of less than or equal to 100 parts per million by weight, or less than or equal to 75 ppm, or less than or equal to 50 ppm. When this definition is applied to the flame retardant it is based on the total weight of the flame retardant. When this definition is applied to the flame retardant composition it is based on the total parts by weight of the flame retardant composition.

The amounts of the various components of the flame retardant compositions may be varied depending on the identity of each component and the desired properties. The flame retardant compositions may include 34-94 wt % or 65-75 wt % of a homopolycarbonate, a copolycarbonate, or a combination thereof, preferably a bisphenol A homopolycarbonate; 5-85 wt % or 15-50 wt % of the poly(carbonate-siloxane), in an amount effective to provide 2-6 wt % dimethyl siloxane; 0.05-0.6 wt %, preferably 0.1-0.4 wt %, of the C₁₋₁₆ alkyl sulfonate salt flame retardant; 1-15 wt % or 1-10 wt % of the mineral-filled silicone flame retardant synergist; 0.01-0.5 wt % or 0.5 to 5 wt % of an anti-drip agent; and optionally, 0.001-10 wt % or 1 to 5 wt % of an additive composition, wherein each amount is based on the total weight of the flame retardant composition, which sums to 100 wt %. In another aspect, the flame retardant composition may include 65-75 wt % of a bisphenol homopolycarbonate a weight average molecular weight from 25,000 to 35,000 grams/mole, preferably 27,000 to 32,000 grams/mole; 15-25 wt % of the poly(carbonate-siloxane);0.2-0.6 wt %, preferably 0.1-0.4 wt % of potassium perfluorobutane sulfonate as the C₁₋₁₆ alkyl sulfonate salt flame retardant; 1-10 wt % of the mineral-filled poly(dimethylsiloxane) flame retardant synergist; 0.05-0.5 wt % anti-drip agent; optionally, up to 5 wt % of an additive composition, or up to 20 wt % of a glass fiber composition, or a combination thereof, wherein each amount is based on the total weight of the flame retardant composition, which sums to 100 wt %. In either of these aspects, the amount of the mineral-filled silicone flame retardant synergist may be 1-12 wt %, 1-10 wt %, 1-8 wt %, 1-5 wt %, 2-15 wt %, 2-12 wt %, 2-10 wt %, 1-8 wt %, 2-5 wt %, 3-15 wt %, 3-12 wt %, 3-8 wt %, 4-15 wt %, 4-12 wt %, 4-10 wt %, 4-8 wt %, 5-15 wt %, 5-12 wt %, or 5-10 wt %.

The flame retardant compositions may be manufactured by various methods. For example, powdered polycarbonates, flame retardant, or other optional components are first blended, optionally with any fillers in a HENSCHEL-Mixer high speed mixer. Other low shear processes, such as hand mixing, may also accomplish this blending. The blend is then fed into the throat of a twin-screw extruder via a hopper. Alternatively, at least one of the components, for example the reinforcing filler, or glass fibers may be incorporated into the composition by feeding directly into the extruder at the throat or downstream through a sidestuffer. Additives such as the mineral-reinforced silicon synergist may also be compounded into a masterbatch with a desired polymeric polymer and fed into the extruder. The extruder is generally operated at a temperature higher than that necessary to cause the composition to flow. The extrudate is immediately quenched in a water bath and pelletized. The pellets so prepared may be one-fourth inch long or less as desired. Such pellets may be used for subsequent molding, shaping, or forming.

A molded sample of the flame retardant composition may have a Vicat softening temperature of at least 140° C., measured in accordance with the ISO-306 standard on 4 mm-thick ISO bars at a load of 10 N and a heating rate of 50° C./hr (B50).

A molded sample of the flame retardant composition may have a notched Izod impact of greater than or equal to 35 kJ/m² performed on notched 4 mm-thick ISO bars at −30 ° C., in accordance with the ISO-180:2000 standard with a 5.5 J hammer.

A molded sample of the flame retardant composition has a flame test rating of V0, as measured according to UL-94 at a thickness of 1.0 millimeter, preferably 0.8 millimeter.

The flame retardant compositions may be used in articles including a molded article, a thermoformed article, an extruded film, an extruded sheet, one or more layers of a multi-layer article, a substrate for a coated article, or a substrate for a metallized article. Optionally, the article has no significant part distortion or discoloration when the article is subjected to a secondary operation such as over-molding, lead-free soldering, wave soldering, low temperature soldering, or coating, or a combination thereof. The articles may be partially or completely coated with, e.g., a hard coat, a UV protective coat, an anti-refractive coat, an anti-reflective coat, a scratch resistant coat, or a combination thereof, or metallized.

Shaped, formed, or molded articles comprising the flame retardant compositions are also provided. The flame retardant compositions may be molded into useful shaped articles by a variety of methods, such as injection molding, extrusion, rotational molding, blow molding and thermoforming. Some examples of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like.

This disclosure is further illustrated by the following examples, which are non-limiting.

### EXAMPLES

The materials in Table 1 were used.

TABLE 1

| Component | Description (Trade name) | Source |
|---|---|---|
| PC-2 | Linear poly (bisphenol A carbosate), Mw = 30,000-31,000 g/mol per | SABIC |
| | GPC using bisphenol A homopoly carbonate standards | |
| PC-Si | Polydimethylsiloxane)-bisphenol A polycarbonate | SABIC |
| | copolymer, produced via interfacial polymerization, | |
| | 20 wt % siloxane, average PDMS block length of 45 | |
| | units (D45), Mw = 29,000 to 31,000 g/mol, as | |
| | determined by GPC using bisphenol | |
| | A homopolycarbonate standards, para- | |
| | cumylphenol (PCP) end-capped, PDI = 2-3 | |
| Rimar | Potassium perfluorobutane sulfonate | 3M |
| KSS | Potassium diphenylsulfone sulfonate | Sloss |
| | | Industries |
| AO | Hindered phenolic antioxidant, available as | Ciba |
| | IRGANOX 1076 | |
| PETS | Pentaerythritol tetrastearate | Faci |
| TSAN | Styrene-acrylonitrile (SAN)-encapsulated PTFE | SABIC |
| Stab | Tris(2,4-di-tert-butylphenyl) phosphite, | Ciba-Geigy |
| | available as IRGAFOS 168 | |
| Si-FR | DynaSil ™ 1350N2 from Polymer Dynamix | Dynamix |
| MBS | Methyl methacrylate-butadiene-styrene | Dow |
| | | Chemical |

The samples were prepared as described below and the following test methods were used.

All powder additives were combined together with the polycarbonate powder(s), using a paint shaker, and fed through one feeder to an extruder. Extrusion for all combinations was performed on a 25 mm twin screw extruder according to the extrusion profile in Table 2.

TABLE 2

| Parameters | Unit | Typical values |
|---|---|---|
| Feed | ° C. | 40 |
| Zone 1 Temp | ° C. | 200 |
| Zone 2 Temp | ° C. | 250 |
| Zone 3 Temp | ° C. | 270 |
| Zone 4-9 Temp | ° C. | 310 |
| Screw Speed | rpm | 300 |
| Throughput | kg/h | ~14 |
| Torque | % | Max. |

Molding of specimens for testing was performed on an Engel 45 Ton injection molding machine equipped with insert molds from AXXICON. Temperature profiles and general molding parameters used for standard and abusive conditions are reported in Table 3.

TABLE 3

| Parameters | Unit | Conditions |
|---|---|---|
| Drying Temperature | ° C. | 120 |
| Drying Time | h | 2 |
| Hopper temperature | ° C. | 40 |
| Nozzle Temperature | ° C. | 305 |
| Rear-Zone 1 Temperature | ° C. | 290 |
| Middle-Zone 2 Temperature | ° C. | 300 |
| Front-Zone 3 Temperature | ° C. | 310 |
| Residence time | min | 5 |

Melt volume rate (MVR) was determined at 300° C. using a 1.2-kilogram weight, over 300 seconds in accordance with ASTM D1238-04.

ISO notched Izod impact measurements (INI) were performed on notched 4 mm-thick ISO bars at -30° C., in accordance with the ISO-180:2000 standard with a 5.5 J hammer.

Vicat softening temperature (Vicat) was measured on 4 mm thick ISO bars in accordance with the ISO-306 standard at a load of 10 N and a heating rate of 50° C./hr (B50).

Flammability was determined by using the UL-94 standard (Table 4). Vx vertical flammability tests were performed at 1.0 mm and 0.8 mm. V-ratings were obtained for every set of 5 bars. In some cases, a second set of 5 bars was tested to give an indication of the robustness of the rating.

TABLE 4

| | t₁ and/or t₂ | 5-bar FOT* | burning drips |
|---|---|---|---|
| V0 | <10 | <50 | no |
| V1 | <30 | <250 | no |
| V2 | <30 | <250 | yes |
| N.R. (no rating) | >30 | >250 | |

*FOT: total flame-out-time for all 5 bars (FOT = t1 + t2)

### Examples 1-13

The formulations and properties of Example 1-13 are shown in Table 5.

TABLE 5

| | Unit | 1* | 2* | 3* | 4* | 5* | 6* | 7 | 8* | 9* | 10* | 11 | 12 | 13* |
|---|---|---|---|---|---|---|---|---|---|---|---|---|---|---|
| PC-2 | wt % | 98.95 | 93.95 | 94.25 | 94.95 | 89.95 | 76.95 | 71.95 | 71.95 | 72.35 | 77.25 | 74.75 | 72.25 | 69.75 |
| PC-Si | wt % | | | | | | 22 | 22 | 22 | 22 | 22 | 22 | 22 | 22 |
| Stab | wt % | 0.05 | 0.05 | 0.05 | 0.05 | 0.05 | 0.05 | 0.05 | 0.05 | 0.05 | 0.05 | 0.05 | 0.05 | 0.05 |
| PETS | wt % | 0.3 | 0.3 | 0.3 | 0.3 | 0.3 | 0.3 | 0.3 | 0.3 | 0.3 | 0.3 | 0.3 | 0.3 | 0.3 |
| MBS | wt % | | | | 4 | 4 | | | | | | | | |
| TSAN | wt % | 0.3 | 0.3 | 0.3 | 0.3 | 0.3 | 0.3 | 0.3 | 0.3 | 0.3 | 0.3 | 0.3 | 0.3 | 0.3 |
| Rimar | wt % | 0.4 | 0.4 | 0.1 | 0.4 | 0.4 | 0.4 | 0.4 | | | 0.1 | 0.1 | 0.1 | 0.1 |
| KSS | wt % | | | | | | | | 0.4 | | | | | |
| Si-FR | wt % | | 5 | 5 | | 5 | | 5 | 5 | 5 | | 2.5 | 5 | 7.5 |
| Total | wt % | 100 | 100 | 100 | 100 | 100 | 100 | 100 | 100 | 100 | 100 | 100 | 100 | 100 |
| Vicat | ° C. | 145.6 | 144.7 | 145.1 | 144.8 | 144.1 | 143.8 | 143.7 | 142.9 | 143.5 | 144.3 | 143.6 | 143.1 | 142.8 |
| B/50 | | | | | | | | | | | | | | |
| INI | kj/m² | 12.3 | 15.4 | 18.8 | 49.5 | 41.2 | 68.2 | 63.3 | 50.1 | 54.6 | 64.1 | 45.5 | 39.3 | 44.4 |
| −30° C. | | | | | | | | | | | | | | |
| MVR | cm³/ | 5.9 | 6.1 | 6.3 | 4.2 | 3.8 | 4.2 | 4.4 | 5.0 | 3.8 | 4.7 | 4.9 | 6.0 | 5.3 |
| | 10 min | | | | | | | | | | | | | |
| UL94 | | V0 | V1 | NR | NR | NR | V1 | V0 | V1 | V0 | V1 | V0 | V0 | V1 |
| 1.0 mm | | | | | | | | | | | | | | |
| FOT, | s | 12 | 36 | 115 | 170 | 192 | 79 | 39 | 68 | 37 | 42 | 30 | 26 | 66 |
| 1.0 mm | | | | | | | | | | | | | | |
| UL94 | | V0 | V1 | NR | NR | NR | V1 | V0 | V2 | V2 | NR | V0 | V0 | NR |
| 0.8 mm | | | | | | | | | | | | | | |
| FOT, | s | 17 | 74 | 96 | 154 | 174 | 35 | 38 | 64 | 99 | 83 | 27 | 10 | 193 |
| 0.8 mm | | | | | | | | | | | | | | |

*Comparative examples

Comparative Example 1 shows that the absence of Si-FR and PC-Si resulted in a V0 UL94 rating at thicknesses of 1.0 mm and 0.8 mm and poor low temperature impact resistance. The addition of Si-FR to the flame retardant compositions wherein PC-Si was absent and Rimar loading was 0.4 wt % failed to improve the low-temperature impact resistance and adversely affected the flame test rating in improved impact resistance (compare Comparative Example 2 with Comparative Example 1). Reducing the Rimar loading from 0.4 wt % to 0.1 wt % resulted in both poor flame test rating at 1.0 mm and 0.8 mm thicknesses and poor low-temperature impact resistance (compare Comparative Example 3 with Comparative Example 2). Comparative Example 4 shows that incorporation of an impact modifier (i.e. MBS) in a composition wherein Si-FR and PC-Si are absent resulted in an improvement in the low-temperature impact resistance, but a deterioration of the flame test ratings (compare Comparative Example 4 with Comparative Example 3). The combination of Si—FR and MBS failed to improve the low-temperature impact resistance (compare Comparative Example 5 with Comparative Example 4). As shown in Example 7, the combination of PC—Si and Si—FR in a composition with 0.4 wt % Rimar salt loading resulted in a flame test rating of V0 at both the 1.0 mm and 0.8 mm thicknesses, as well as an improved low-temperature impact resistance (INI, −30 C>60 kJ/m²). Replacement of Rimar salt with KSS resulted in an adverse effect on the flame test ratings at both 1.0 mm and 0.8 mm thicknesses (compare Comparative Example 8 with Example 7). A composition having a combination of PC—Si and Si—FR and excluding Rimar salt and KSS flame retardants resulted in V0 at a thickness of 1.0 mm and V2 at a thickness of 0.8 mm (see Comparative Example 9). Comparative Example 10 shows that a composition having PC—Si, but not Si—FR at a lower loading of Rimar salt (i.e., 0.1 wt %) failed to provide improved flame test ratings at the 1.0 mm and 0.8 mm thicknesses (compare Comparative Example 10 with Comparative Example 6). However, the combination of PC—Si and Si—FR, even at the lower Rimar salt loading of 0.1 wt % resulted in the combination of V0 flame test ratings at both 1.0 mm and 0.8 mm thicknesses and good low-temperature impact resistance (Example 11). Example 12 shows that when the loading of Si-FR is increased from 2.5 wt % to 5 wt %, that the desired combination of V0 flame test ratings at both 1.0 mm and 0.8 mm thicknesses and good low-temperature impact resistance is obtained. Comparative Example 13 shows that in compositions having a combination of PC—Si (22 wt %) and Si—FR wherein Rimar salt is present at 0.1 wt % loading, that increasing the Si-FR loading from 5 wt % to 7.5 wt % resulted in a loss of V0 flame test ratings at both the 1.0 mm and 0.8 thicknesses. To summarize, the combination of PC—Si, Si—FR, and Rimar resulted in the desired combination of V0 flame test ratings at both 1.0 mm and 0.8 mm thicknesses and good low-temperature impact resistance (i.e., greater than 35 kJ/m² at −30° C.).

The following aspects are illustrative of possible embodiments.

Aspect 1. A flame retardant composition comprising: 34-94 wt % of a homopolycarbonate, a copolycarbonate, or a combination thereof; 5-85 wt % poly(carbonate-siloxane), in an amount effective to provide 2-6 wt % dimethyl siloxane; 0.05-0.6 wt %, preferably 0.1-0.4 wt %, of a C₁₋₁₆ alkyl sulfonate salt flame retardant; 1-15 wt % of a mineral-filled silicone flame retardant synergist; 0.05-0.5 wt % of an anti-drip agent; optionally, 0.001-10 wt % of an additive composition, or 0.1-20 wt % of a glass fiber composition, or a combination thereof, wherein each amount is based on the total weight of the flame retardant composition, which sums to 100 wt %; and wherein a molded sample of the flame retardant composition has a Vicat softening temperature of greater than or equal to 140° C. as measured according to the ISO-306 standard at a load of 10 N and a heating rate of 50° C. per hour, and a flame test rating of V0 as measured according to UL-94 at a thickness of 1.0 millimeter, or at a thickness of 0.8 millimeter.

Aspect 2. The flame retardant composition according to claim 1, wherein a molded sample of the flame retardant composition has a notched Izod impact resistance measured according to the ISO-180:2000 standard with a 5.5 joule hammer on a 4 millimeter specimen at −30° C. of greater than or equal to 35 kJ/m²; a melt volume rate of greater than or equal to 5 centimeters cubed per 10 minutes at 300° C. using a 1.2-kilogram weight, in accordance with ASTM D1238-04; or a combination thereof.

Aspect 3. The flame retardant composition of any one of the preceding claims, wherein the homopolycarbonate or copolycarbonate comprises bisphenol A repeating units.

Aspect 4. The flame retardant composition of any one of the preceding claims, wherein the homopolycarbonate is present, and comprises a bisphenol A homopolycarbonate having a weight average molecular weight from 20,000 to 30,000 grams/mole, preferably 20,000 to 25,000 grams/mole; a bisphenol A homopolycarbonate having a weight average molecular weight from 25,000 to 35,000 grams/mole, preferably 27,000 to 32,000 grams/mole; or a combination thereof, each as measured via gel permeation chromatography using bisphenol A homopolycarbonate standards.

Aspect 5. The flame retardant composition of any one of the preceding claims, wherein the poly(carbonate-siloxane) comprises 5 to 99 weight percent of bisphenol A carbonate units and 1 to 50 weight percent of dimethylsiloxane units, each based on the weight of the polydimethylsiloxane.

Aspect 6. The flame retardant composition of any one of the preceding claims, wherein the silicone of the mineral-containing silicone flame retardant synergist is a polydiorganosiloxane, preferably a polydimethylsiloxane.

Aspect 7. The flame retardant composition of any one of the preceding claims, wherein the C₁₋₁₆ alkyl sulfonate salt flame retardant comprises potassium perfluorobutane sulfonate, potassium perfluoroctane sulfonate, tetraethylammonium perfluorohexane sulfonate, or a combination thereof, preferably potassium perfluorobutane sulfonate.

Aspect 8a. The flame retardant composition of any one of the preceding claims, wherein the mineral-filled silicone flame retardant synergist is a silicone flame retardant additive present in an amount of 1-99 wt %, or 1-75 wt %, or 1-50 wt %, or 1-25 wt %, or 1 to 20 wt % in combination with a mineral filler synergist present in an amount of 1-99 wt %, or 25-99 wt %, or 50-99 wt %, or 75-99 wt %, or 80-90 wt %, each based on the total weight of the combination.

Aspect 8b. The flame retardant composition of any one of the preceding claims, wherein the mineral-filled silicone flame retardant synergist comprises 1-20 wt % silicon, or 2-18 wt % silicon, or 3-15 wt % silicone, or 5-12 wt % silicon, or 6-10 wt % silicon, or 7-8 wt % silicon.

Aspect 9. The flame retardant composition of any one of the preceding claims, wherein the anti-drip agent comprises a fluoropolymer, preferably a polymer-encapsulated fluoropolymer, more preferably a polytetrafluoroethylene-encapsulated styrene-acrylonitrile copolymer, or a combination thereof.

Aspect 10. The flame retardant composition of any one or more of the preceding claims comprising 65-75 wt % of a bisphenol homopolycarbonate a weight average molecular weight from 25,000 to 35,000 grams/mole, preferably 27,000 to 32,000 grams/mole; 15-70 wt % of the poly(carbonate-siloxane);0.2-0.6 wt %, preferably 0.2-0.4 wt % of potassium perfluorobutane sulfonate as the C₁₋₁₆ alkyl sulfonate salt flame retardant; 1-10 wt % of the mineral-filled poly(dimethylsiloxane) flame retardant synergist; 0.01-0.5 wt % anti-drip agent; optionally, 0.01 to 5 wt % of an additive composition, or 0.1-10 wt % of a glass fiber composition, or a combination thereof wherein each amount is based on the total weight of the flame retardant composition, which sums to 100 wt %.

Aspect 11. The flame retardant composition of any one of the preceding claims, wherein the additive is present and the additive comprises a particulate filler, reinforcing agent (e.g, glass fibers), antioxidant, heat stabilizer, light stabilizer, ultraviolet light stabilizer, plasticizer, lubricant, mold release agent, antistatic agent, surface effect additive, radiation stabilizer, a flame retardant different from the C₁₋₁₆ alkyl sulfonate salt flame retardant and the mineral-filled poly(dimethylsiloxane) flame retardant synergist, or a combination thereof

Aspect 12. An article of any one of the preceding claims, wherein the article is an extruded article, a molded article, pultruded article, a thermoformed article, a foamed article, a layer of a multi-layer article, a substrate for a coated article, or a substrate for a metallized article, preferably wherein the article is a molded article.

Aspect 13. The article of claim 12, wherein the article is a molded housing.

Aspect 14. The article of claim 12 or 13, wherein the article is an electrical circuit housing.

Aspect 15. A method for forming the article of any one or more of the preceding claims, comprising molding, casting, or extruding the article.

The compositions, methods, and articles may alternatively comprise, consist of, or consist essentially of, any appropriate materials, steps, or components herein disclosed. The compositions, methods, and articles may additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt % to 20 wt %”, is inclusive of the endpoints and all intermediate values of the ranges of “5 wt % to 25 wt %,” etc.). “Combinations” is inclusive of blends, mixtures, alloys, reaction products, and the like. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some aspects,” “an aspect,” and so forth, means that a particular element described in connection with the aspect is included in at least one aspect described herein, and may or may not be present in other aspects. In addition, it is to be understood that the described elements may be combined in any suitable manner in the various aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, -CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃-)). “Cycloalkylene” means a divalent cyclic alkylene group, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups may be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that may each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A flame retardant composition comprising:
34-94 wt % of a homopolycarbonate, a copolycarbonate, or a combination thereof;
5-85 wt % poly(carbonate-siloxane), in an amount effective to provide 2-6 wt % dimethyl siloxane;
0.05-0.6 wt % of a C₁₋₁₆ alkyl sulfonate salt flame retardant;
1-15 wt % of a mineral-filled silicone flame retardant synergist;
0.05-0.5 wt % of an anti-drip agent;
optionally, 0.001-10 wt % of an additive composition, or 0.1-20 wt % of a glass fiber composition, or a combination thereof
wherein each amount is based on the total weight of the flame retardant composition, which sums to 100 wt %; and
wherein a molded sample of the flame retardant composition has
a Vicat softening temperature of greater than or equal to 140° C. as measured according to the ISO-306 standard at a load of 10 N and a heating rate of 50° C. per hour, and
a flame test rating of V0 as measured according to UL-94 at a thickness of 1.0 millimeter, or at a thickness of 0.8 millimeter.

2. The flame retardant composition according to claim 1, wherein a molded sample of the flame retardant composition has
a notched Izod impact resistance measured according to the ISO-180:2000 standard with a 5.5 joule hammer on a 4 millimeter specimen at −30° C. of greater than or equal to 35 kilojoules per square meter;
a melt volume rate of greater than or equal to 5 centimeters cubed per 10 minutes at 300° C. using a 1.2-kilogram weight, in accordance with ASTM D1238-04;
or a combination thereof.

3. The flame retardant composition of claim 1, wherein the homopolycarbonate or copolycarbonate comprises bisphenol A repeating units.

4. The flame retardant composition of claim 1, wherein the homopolycarbonate is present, and comprises
a bisphenol A homopolycarbonate having a weight average molecular weight from 20,000 to 30,000 grams/mole;
a bisphenol A homopolycarbonate having a weight average molecular weight from 25,000 to 35,000 grams/mole;
or a combination thereof, each as measured via gel permeation chromatography using bisphenol A homopolycarbonate standards.

5. The flame retardant composition of claim 1, wherein the poly(carbonate-siloxane) comprises 5 to 99 weight percent of bisphenol A carbonate units and 1 to 50 weight percent of dimethylsiloxane units, each based on the weight of the polydimethylsiloxane.

6. The flame retardant composition of claim 1, wherein the silicone of the mineral-containing silicone flame retardant synergist is a polydiorganosiloxane.

7. The flame retardant composition of claim 1, wherein the C₁₋₁₆ alkyl sulfonate salt flame retardant comprises potassium perfluorobutane sulfonate, potassium perfluoroctane sulfonate, tetraethyl ammonium perfluorohexane sulfonate, or a combination thereof.

8. The flame retardant composition of claim 1, wherein
the mineral-filled silicone flame retardant synergist comprises 1-20 wt % silicon, or 2-18 wt % silicon, or 3-15 wt % silicone, or 5-12 wt % silicon, or 6-10 wt % silicon, or 7-8 wt % silicon; or
wherein the mineral-filled silicone flame retardant synergist is a silicone flame retardant additive present in an amount of 1-99 wt %, or 1-75 wt %, or 1-50 wt %, or 1-25 wt %, or 1 to 20 wt % in combination with a mineral filler synergist present in an amount of 1-99 wt %, or 25-99 wt %, or 50-99 wt %, or 75-99 wt %, or 80-90 wt %, each based on the total weight of the combination.

9. The flame retardant composition of claim 1, wherein the anti-drip agent comprises a fluoropolymer.

10. The flame retardant composition of claim 1 comprising
65-75 wt % of a bisphenol homopolycarbonate a weight average molecular weight from 25,000 to 35,000 grams/mole;
15-70 wt % of the poly(carbonate-siloxane);
0.05-0.6 wt % of potassium perfluorobutane sulfonate as the C₁₋₁₆ alkyl sulfonate salt flame retardant;
1-10 wt % of the mineral-filled poly(dimethylsiloxane) flame retardant synergist;
0.01-0.5 wt % anti-drip agent;
optionally, 0.01-5 wt % of an additive composition, or 1-20 wt % of a glass fiber composition, or a combination thereof;
wherein each amount is based on the total weight of the flame retardant composition, which sums to 100 wt %.

11. The flame retardant composition of claim 1, wherein the additive is present and the additive comprises a filler, a reinforcing agent, an antioxidant, a heat stabilizer, a light stabilizer, an ultraviolet light stabilizer, a plasticizer, a lubricant, a mold release agent, an antistatic agent, a surface effect additive, a radiation stabilizer, a flame retardant different from the C₁₋₁₆ alkyl sulfonate salt flame retardant and the mineral-filled poly(dimethylsiloxane) flame retardant synergist, or a combination thereof.

12. An article of claim 1,
wherein the article is an extruded article, a molded article, pultruded article, a thermoformed article, a foamed article, a layer of a multi-layer article, a substrate for a coated article, or a substrate for a metallized article.

13. The article of claim 12, wherein the article is a molded housing.

14. The article of claim 12, wherein the article is an electrical circuit housing.

15. A method for forming the article of claim 12, comprising molding, casting, or extruding the article.

16. The flame retardant composition of claim 1, wherein the homopolycarbonate is present, and comprises
a bisphenol A homopolycarbonate having a weight average molecular weight from 20,000 to 25,000 grams/mole;
a bisphenol A homopolycarbonate having a weight average molecular weight from, preferably 27,000 to 32,000 grams/mole;
or a combination thereof, each as measured via gel permeation chromatography using bisphenol A homopolycarbonate standards.

17. The flame retardant composition of claim 1, wherein the polydiorganosiloxane is a polydimethylsiloxane.

18. The flame retardant composition of claim 1, wherein the C₁₋₁₆ alkyl sulfonate salt flame retardant comprises potassium perfluorobutane sulfonate.

19. The flame retardant composition of claim 1 comprising
65-75 wt % of a bisphenol homopolycarbonate a weight average molecular weight from 27,000 to 32,000 grams/mole;
15-70 wt % of the poly(carbonate-siloxane);
0.2-0.4 wt % of potassium perfluorobutane sulfonate as the C₁₋₁₆ alkyl sulfonate salt flame retardant;
1-10 wt % of the mineral-filled poly(dimethylsiloxane) flame retardant synergist;
0.01-0.5 wt % anti-drip agent;
optionally, 0.01-5 wt % of an additive composition, or 1-20 wt % of a glass fiber composition, or a combination thereof;
wherein each amount is based on the total weight of the flame retardant composition, which sums to 100 wt %.

20. The article of claim 12, wherein the article is a molded article.
